(19) United States
(12) Patent Application Publication
(10) Pub. No.: US 2013/0062575 A1
(43) Pub. Date: Mar. 14, 2013

(54) METAL IMIDE COMPOUNDS AS ANODE MATERIALS FOR LITHIUM BATTERIES AND GALVANIC ELEMENTS WITH A HIGH STORAGE CAPACITY

(71) Applicant: Ulrich Wietelmann, Friedrichsdorf (DE)

(72) Inventor: Ulrich Wietelmann, Friedrichsdorf (DE)

(73) Assignee: CHEMETALL GMBH, Frankfurt am Main (DE)

(21) Appl. No.: 13/636,014

(22) PCT Filed: Mar. 31, 2011
(86) PCT No.: PCT/EP2011/055035

§ 371 Date: Nov. 29, 2012

(30) Foreign Application Priority Data
Mar. 21, 2010 (DE) 102010113501.7

(51) Int. Cl. H01M 4/58; H01M 4/04; C01B 21/092

(52) U.S. Cl. CPC H01M 4/58; C01B 21/0926; H01M 4/043
USPC 252/509; 252/182.1; 423/413; 252/506; 427/126.1; 427/122

(57) ABSTRACT

Metal imide compounds as anode materials for lithium batteries and galvanic elements with a high storage capacity. Metal imide compounds as highly capacitive anode materials for lithium batteries. The invention relates to a galvanic element, an anode material for use in a galvanic element and method for producing an active electrode material. The galvanic element contains the metal imide compounds of the general formula (I): M¹₄₋₂ₓM²ₓ(NH)₂·y M¹NH₂ (I), where M¹=alkali metal (Li, Na, K, Rb, Cs or any desired mixture thereof), M²=alkaline earth metal element (Mg, Ca, Sr, Ba or any desired mixture thereof), and x and y independently of one another represent a number between 0 and 1 in the discharged state, or the metal imide compounds of the general formula (II): Li₄M¹₄₋₂ₓM²ₓ(NH)₂·y LiH (II), where M¹=alkali metal (Li, Na, K, Rb, Cs or any desired mixture thereof), M²=alkaline earth metal element (Mg, Ca, Sr, Ba or any desired mixture thereof), and x and y independently of one another represent a number between 0 and 1 in the charged state.

Currently used rechargeable lithium batteries contain graphite as anode material. Graphite functions as lithium insertion material, and according to the equation

Li+6C→LiC₆

has a theoretical capacitance of 372 mAh/g at a potential of approximately 0.2 V relative to Li/Li⁺. Use cannot be made of the significantly higher storage capacitance of lithium metal (3860 mAh/g) in batteries in practical application, since such batteries are not safe or cyclically stable. During cycling, the lithium metal sometimes separates not in planar form, but in the form of needle-shaped outgrowths (dendrites). These outgrowths may lose physical contact with the metal anode, causing the capacitance of the electrochemical cell to decrease. Even more serious are the consequences when such needle-shaped dendrites penetrate the separator. The battery cell may thus be short-circuited, with often catastrophic effects: thermal run-away, usually accompanied by fire.

Therefore, efforts have been made to use metal lithium alloys instead of pure lithium as anode material. However, lithium alloys exhibit extreme fluctuations in volume during insertion and deinsertion of the lithium (sometimes by several multiples of 100%, for example 238% for Li₉Al₄). For this reason, alloy anodes have not been commercially successful, with the exception of tin-graphite composites. However, tin is a rare and expensive element, which has prevented the widespread use of materials containing tin.

Tarascon and Aymard have proposed a battery in which in the discharged state a metal hydride MH_{z}, and in the charged state, a mixture of lithium hydride with the metal, is used as the negative electrode (anode) (EP 2026390 A2):

MHₓ+Li⁺+e⁻ [symbol] ×LiH+M (1)

where M=La, Mg, Ni, Na,

However, the Mg-based system described in detail in the above-cited patent document has pronounced hysteresis, and heretofore its functionality has not been demonstrated in an actual lithium battery.

An anode material is sought which avoids the disadvantages of the prior art, i.e., which has
a high capacitance (>>372 mAh/g),
does not contain expensive or toxic components, and
and at the same time is able to accept lithium while maintaining the basic spatial structure, and therefore has good cycle stability.

It has surprisingly been found that a galvanic element containing metal imide compounds of general formula (I)

M¹₄₋₂ₓM²ₓ(NH)₂·yM¹NH₂ (I), where
M¹=alkali metal (Li, Na, K, Rb, Cs, or any given mixture thereof)
M²=alkaline earth element (Mg, Ca, Sr, Ba, or any given mixture thereof)
x and y independently represent a number between 0 and 1 in the discharged state,
or metal imide compounds of general formula (II)

Li₄M¹₄₋₂ₓM²ₓ(NH)₂·yLiH (II), where
M¹=alkali metal (Li, Na, K, Rb, Cs, or any given mixture thereof)
M²=alkaline earth element (Mg, Ca, Sr, Ba, or any given mixture thereof)
x and y independently represent a number between 0 and 1 in the charged state,
   has a high reversible storage capacity. The general, reversible electrode reaction is as follows:

M¹₄₋₂ₓM²ₓ(NH)₂+4Li⁺+4 e⁻ [symbol] Li₄M¹₄₋₂ₓM²ₓ(NH)₂ (3)

To achieve a particularly high specific capacitance, it is preferred that M¹ and M² have the smallest possible atomic mass, i.e., M¹ is preferably Li and M² is preferably Mg or Ca.

In the discharged state, the galvanic element preferably contains or is composed of Li₂NH, MgNH, Li₂Mg(NH)₂, Li₂Ca(NH)₂, MgCa(NH)₂, Li₄Mg(NH)₃, or Li₂Mg₂(NH)₃ as active anode material.

Likewise, in the charged state the galvanic element preferably contains or is composed of Li₄NH, Li₂MgNH, Li₆Mg(NH)₂, Li₆Ca(NH)₂, Li₄MgCa(NH)₂, Li₁₀Mg(NH)₃, or Li₈Mg₂(NH)₃ as active anode material.

Particularly preferred redox pairs are as follows:

Li₂NH+2Li⁺+2e⁻ [symbol] Li₄NH (4)

and

MgNH+2Li⁺+2e⁻ [symbol] Li₂MgNH (5)

as well as

Li₂M₂(NH)₂+4Li⁺+4e⁻ [symbol] Li₆M²(NH)₂(M²=Mg, Ca) (6)

and

MgCa(NH)₂+4LF⁺+4e⁻ [symbol] Li₆MgCa(NH)₂ (7)

Mixtures of the metal imide anode materials according to the invention may also be used. This may be a purely mechanical mixture, or may involve structurally uniform compounds such as compounds of the type Li₄M²(NH)₃ or Li₂M²₂(NH)₃ (M²=Mg, Ca, Sr, or Ba). Examples are Li₄Mg(NH)₃, which, strictly speaking, is a mixture of Li₂Mg(NH)₂ and Li₂NH (see K. J. Michel, A. R. Akbarzadeh, V, Ozolins, J. Phys. Chem. C. 2009, 113, 14551-14558), and Li₂Mg₂(NH)₃, a composite compound of Li₂Mg(NH)₂ and MgNH (see E. Weidner at al., J. Phys. Chem, C 2009, 113, 15772-15777).

The theoretical capacitances for the seven particularly preferred anode systems listed above are computed based on the discharged form, as follows:

| Anode material | Formula | Insertable | Theoretical |
|---|---|---|---|
| (charged) | mass (g/mol) | lithium (mol equiv) | capacitance (Ah/kg) |
| Li₂NH | 28.88 | 2 | 1856 |
| MgNH | 39.31 | 2 | 1364 |
| Li₂Mg(NH)₂ | 8.13 | 4 | 1574 |
| Li₂Ca(NH)₂ | 77.02 | 4 | 1392 |
| MgCa(NH)₂ | 94.38 | 4 | 1136 |
| Li₄Mg(NH)₃ | 97.07 | 6 | 1657 |
| Li₂Mg₂(NH)₃ | 107.49 | 6 | 1496 |

Thus, all particularly preferred anode materials based on metal imide have at least three times the theoretical capacitance compared to the prior art (graphite).

Besides the above-described compounds, nitride hydrides of the general composition M²₂LiH₂N, where M²=Mg, Ca, Sr, Ba, or any given mixture thereof, may be used. A typical example is Sr₂LiH₂N (see D. M. Liu, Q. Q. Liu, T. Z. Si, Q. A. Zhang, Journal of Alloys and Compounds, 495, Apr. 9, 2010, 272-274), which may be used as a metal imide anode material within the meaning of the invention.

It has surprisingly been found that the lithium intake or release occurs without basic morphological structural changes, i.e., by insertion or deinsertion of lithium into/from the ion lattice structure of the binary (x=0) or ternary (1≧x≧0) M¹/M²/N/H phases.

The metal imide compounds according to the invention may be used either in the (partially) lithium-charged or in the (partially) discharged (delithiated) form, depending on the type of counter electrode (cathode). The delithiated anode form is employed when a lithium-charged cathode material is used, while the opposite applies for the lithiated anode form. This is explained with reference to two examples:

The delithiated anode form, for example lithium imide (Li₂NH), may be “connected” to a lithium-charged insertion cathode material, for example lithium manganese spinel (LiMn₂O₄). Accordingly, the electrochemical redox reaction is as follows:

Li₂NH+2LiMn₂O₄ [symbol] Li₄NH+Mn₂O₄ (8)

On the other hand, if the lithium imide-based anode material is to be connected to a lithium-free (or low-lithium) cathode (MnO₂, for example), it is meaningful to use same in the lithium-charged form, i.e., as Li₄NH:

Li₄NH+2MnO₂ [symbol] Li₂NH+2LiMnO₂ (9)

When a partially lithiated form of the anode material is employed, a quantity of the cathode material that is sufficient for the lithium intake is used, either in likewise partially lithiated form or as a mixture of the lithium-charged and the lithium-discharged form. This procedure of electrode balancing is well known to one skilled in the art having knowledge of this subject matter.

The specific capacitance may be further increased by adding lithium amide to the discharged metal imide anode material according to the invention. For example, the theoretical specific capacitance may be increased to 3103 Ah/kg by the equimolar addition of LiNH₂ to lithium imide:

Li₂NH+LiNH₂+6Li⁺+6e⁻ [symbol] 2Li₄NH LiH (10)

The lithium amide is preferably used in finely divided form. Such a powder may preferably be produced from lithium bronze in the presence of a hydrogen acceptor (EP 1238944).

LiNH₂ may be added by admixture with the pure components, although it is also possible to synthesize a structurally uniform mixing phase Li₂₋ₓNH₁₊ₓ, for example by hydrogenation of Li₃N until the desired H content is attained (see D. Chandra et al., DOE Hydrogen Program, FY 2009 Ann. Prog. Rep. 477-482).

As is apparent from equation (10), in the Li intake using lithium amide two separate compounds (LiH and Li₄NH) result; i.e., an insertion mechanism, not a conversion mechanism, is involved. To minimize the mechanical load thus caused on the anode composite, within the meaning of the invention the addition of lithium amide is preferably limited to no more than 1, particularly preferably no more than 0.5, equivalent (eq) per eq of metal imide anode material.

Similarly, the lithium density (i.e., the lithium discharge capacity) of the charged metal imide anode material may be increased by adding lithium hydride, for example as follows:

2Li₄NH+LiH [symbol] Li₂NH+LiNH₂+6Li⁺+6e⁻ (11)

In this case as well, the added LiH completely converts into a different solid phase; i.e., according to the invention the hydride should be added in fairly small quantities. A maximum of 1 eq LiH, in particular a maximum of 0.5 eq, per eq of charged metal imide anode material is added.

The metal imide anode materials according to the invention are sometimes obtained according to the prior art as follows. First, the preparation of the discharged (low-lithium) metal imide anode materials is shown:

Thermal decomposition of metal amides, for example:

Mg(NH₂)₂→MgNH+NH₃ (12)

(see H. Jacobs, R, Juza, Z. Anorg. Alig, Chem, 1969, 370, 254-261).

Comproportionation of metal amides with metal nitrides, for example:

LiNH₂+Li₃N→2Li₂NH (13)

(see Y. H. Hu, E, Ruckenstein, Ind. Eng. Chem. Res. 2006, 45, 4993-4998).

Reaction of metal amides with metal hydrides, for example:

LiNH₂+LiH→Li₂NH+H₂ (14)

Reaction of metal amides with metals, for example:

LiNH₂+2Li→Li₂NH+LiH (15)

The ternary systems are produced by reacting metal amides and metal hydrides of different metals, for example:

2LiNH₂+MgH₂→Li₂Mg(NH)₂+2H₂ (16)

(see Y. Chen et al., Int. J. Hydrogen Energy (2006), 31, 1236-1240).

The syntheses may be carried out either thermally, i.e., at elevated temperatures, frequently in the temperature range between 150 and 500° C. (see Y. Wang, Phys. Rev. B: Condensed Matter and Materials Physics (2007), 76(1), 014116/1-014116/6), or by grinding, i.e., mechanochemically.

Thus, for example, the synthesis of Li₂Ca(NH)₂ by grinding in a ball mill is described:

2LiNH₂+CaH₂→Li₂Ca(NH)₂+2H₂ (17)

(see H. Wu, J. Am. Chem. Soc. 130, 6515-6522 (2008)).

The lithium-charged metal imide anode materials according to the invention are prepared as follows:

Reaction of metal nitrides with metal hydrides, for example:

Li₃N+LiH→Li₄NH (18)

(see R. Marx, Z. Anorg. Allg. Chem. 623 (1997) 1912-1916);

by reacting metal amide and metal nitride in a molten metal bath, for example:

LiNH₂+Li₃N+4Li→2Li₄NH (19)

(see R. Niewa, D. A. Zherebtsov, Kristallogr. NCS 217 (2002) 317-318);

by reacting metal amides with metals, for example:

LiNH₂+4Li→Li₄NH+LiH (20);

by reacting metal imides with metals, for example:

Li₂NH+2Li→Li₄NH (21).

The metal imide-based anode materials according to the invention may be used to produce galvanic elements, using any given cathode materials. Preferred cathode materials include lithiated metal insertion cathodes, preferably layer-structured materials such as LiCoO₂, LiNiO₂, Li(Ni,Mn,Co)O₂, LiNi_{0.80}Co_{0.15}Al_{0.05}O₂, and spinel-structured materials such as LiMn₂O₄ and LiNi_{0.5}Mn_{1.5}O₄ and those having an olivine structure, for example LiFePO₄ and LiMnPO₄. Nonlithiated metal insertion compounds such as electrolytic manganese dioxide (MnO₂) or vanadium oxide (V₂O₃), or conversion cathode materials such as metal fluorides (NiF₂, CoF₂, FeF₂, FeF₃, for example) or metal oxyfluorides (BiOₓF₃₋₂ₓ, FeOF, for example), may also be used. Lastly, the cathode may contain or be composed of a lithium oxide (Li₂O or Li₂O₂). The electronically nonconductive cathode materials are made conductive by adding conductivity additives, for example carbon black.

Within the meaning of the invention it is also possible to use any given mixtures of various cathode materials.

Lithium ion-conductive materials (liquid, gel, polymer, and solid electrolytes) known to those skilled in the art are suitable as electrolytes. The lithium salts having weakly coordinating, oxidation-stable anions which are soluble in or otherwise introducible into such products are used as conducting salt. These include, for example, LiPF₆, lithium fluoroalkyl phosphates, LiBF₄, imide salts (LiN(SO₂CF₃)₂ or LiN(SO₂F)₂, for example), lithium triflate (LiOSO₂CF₃), methide salts (LiC(SO₂CF₃)₃, for example), LiClO₄, lithium chelatoborates (for example, LiB(C₂O₄)₂ (“LiBOB”)), lithium fluorochelatoborates (for example, LiC₂O₄BF₂ (“LiDFOB”)), lithium chelatophosphates (for example, LiP(C₂O₄)₃ (“LiTOP”)), and lithium fluorochelatophosphates (for example, Li(C₂O₄)₂PF₂). Salts containing anions which are stable against anion dissociation and fluorine-free are particularly preferred. It has surprisingly been found that electrolytes produced using fluorine-free conducting salts, such as chelatoborates and chelatophosphates, are much more stable in contact with the imide anode materials according to the invention, so that when these are used, galvanic cells result which have greatly improved safety characteristics than when salts containing labile anions (LiPF₆, for example) are used. It is presumed that due to the anion dissociation according to:

LiPF₆→LiF+PF₅ (22)

LiPF₆-based electrolytes form reactive species (the Lewis acid PF₅ and/or secondary products thereof) which are already able to react exothermically with the metal imide anode materials according to the invention at a relatively low temperature.

Fluids selected from the substance classes of the carbonic acid esters, carboxylic acid esters, ethers (THE, MTHF, ethylene glycol dialkyl ether, dioxolane), nitriles, dinitriles, tertiary amines, dialkylsulfoxides, lactones, sulfolane, or ionic liquids, either in pure form or in any given mixtures, are used as electrolytic solvent. When the metal imide anode materials according to the invention are used with high-voltage cathode materials (i.e., active materials having a potential of ≧ approximately 4.5 V relative to Li/Li⁺), oxidation-stable fluids, for example nitriles or ionic liquids, are particularly preferably used as solvent.

Anode sections or strips may be produced by pressing dry powdered mixtures onto a current collector (for example, copper or nickel foil or mesh). For this purpose, the metal imide anode materials according to the invention are mixed with a binder and optionally a conductivity-enhancing additive with exclusion of air and moisture, for example in an argon-filled glove box. In these cases, addition of conductivity additives is unnecessary due to the good intrinsic electronic conductivity of some of the metal imide anode materials. Dispensing with conductivity additives results in a further increase in the specific electrochemical capacitance. Water-free thermoplastic polymer materials such as powdered PTFE are used as binder. This mixture is preferably then ground under an inert gas atmosphere, using a rod mill or ball mill, for example. After the desired particle size distribution is established, the powder mixtures obtained are pressed onto the current collector. This may be carried out using a press or a calender, for example.

The anode mixture may also be produced using a solvent, i.e., produced as a flowable dispersion. For this purpose, the necessary powdered components, i.e., the metal imide-active material, the soluble polymeric binder, and optionally a conductivity additive, are introduced into a solvent in which the binder dissolves, with exclusion of air and moisture, and homogeneously dispersed by intensive stirring or by using an ultrasonic process. This mixture is then applied in flowable form to the current collector in the desired thickness. The solvent is then evaporated, and the dried layer is compressed and homogenized by pressing or calendering. Aprotic liquid substances, i.e., fluids containing no acid protons, are suitable as solvent, and include hydrocarbons, ethers, carbonyl compounds, sulfoxides, tertiary amines, N-alkylpyrrolidones, and dialkylamides. For example, PVDF (commercially available under the trade name “Solef” by Solvay Solexis, for example), is used as binder, with N-methylpyrrolidone (NMP), N-ethylpyrrolidone (NEP), dimethylsulfoxide (DMSO), or γ-butyrolactone (GBL) as solvent, or soluble polydienes, for example polybutadienes (commercially available under the trade name “Busofan”) or also polyisobutylene (commercially available under the trade name “Oppanol”). Polydienes are generally very soluble in hydrocarbons (aromatics, aliphatics, cycloaliphatics), and are therefore preferably dissolved in these fluids, which are particularly chemically resistant and stable against the metal imide anode materials according to the invention, and used for the preparation of anode dispersions. Due to the sometimes insufficient resistance of mixtures of the metal imide anode materials according to the invention with functionalized solvents (i.e., solvents containing functional groups such as O— or N-containing functions), it is preferred to use hydrocarbons as dispersing agent, and polydienes as binder. The combination of polybutenes and saturated hydrocarbons, for example hexane, heptane, octane, nonane, decane, undecane, dodecane, methylcyclohexane, or commercially available hydrocarbon boiling fractions, for example, Shellsol D30 or D100, is very particularly preferred.

The invention relates in particular to the following:
A galvanic element which in the discharged state contains the metal imide compounds of general formula (I)

M¹₄₋₂ₓM²ₓ(NH)₂·yM¹NH₂ (I), where
M¹=alkali metal (Li, Na, K, Rb, Cs, or any given mixture thereof)
M²=alkaline earth element (Mg, Ca, Sr, Ba, or any given mixture thereof)
x and y independently stand for a number between 0 and 1,
or in the charged state contains the metal imide compounds of general formula (II)

Li₄M¹₄₋₂ₓM²ₓ(NH)₂·yLiH (II), where
M¹=alkali metal (Li, Na, K, Rb, Cs, or any given mixture thereof)
M²=alkaline earth element (Mg, Ca, Sr, Ba, or any given mixture thereof)
x and y independently stand for a number between 0 and 1,
A galvanic element which in the discharged state contains or is composed of Li₂NH, MgNH, Li₂Mg(NH)₂, Li₂Ca(NH)₂, MgCa(NH)₂, Li₄Mg(NH)₃, Li₂Mg₂(NH)₃ as active anode material.
A galvanic element which in the charged state contains or is composed of Li₄NH, Li₂MgNH, Li₈Mg(NH)₂, Li₆Ca(NH)₂, Li₄MgCa(NH)₂, Li₁₀Mg(NH)₃. Li₈Mg₂(NH)₃ as active anode material.
A galvanic element in which the lithiated metal insertion cathode contains a layer-structured material such as LiCoO₂, LiNiO₂, Li(Ni,Mn,Co)O₂, LiNi_{0.80}Co_{0.15}Al_{0.05}O₂, or a spinel-structured material such as LiMn₂O₄ or LiNi_{0.5}Mn_{1.5}O₄ or having an olivine structure such as LiFePO₄ or LiMnPO₄, or a nonlithiated metal insertion compound such as electrolytic manganese dioxide (MnO₂) or vanadium oxide (V₂O₃), or a conversion cathode material such as metal fluorides (NiF₂, CoF₂, FeF₂, FeF₃, for example) or metal oxyfluorides (BiOₓF₃₋₂ₓFeOF, for example), or a lithium oxide (Li₂O or Li₂O₂).
A galvanic element which as conducting salt contains lithium salts having weakly coordinating, oxidation-stable anions, for example LiPF₆, lithium fluoroalkyl phosphates, LiBF₄, imide salts (LiN(SO₂CF₃)₂, for example), (LiOSO₂CF₃), methide salts (LiC(SO₂CF₃)₃, for example), LiClO₄, chelatoborates (LiBOB, for example), lithium fluorochelatoborates (LiC₂O₄BF₂, for example), lithium chelatophosphates (LiTOP, for example), and lithium fluorochelatophosphates (Li(C₂O₄)₂PF₂, for example), or any given mixtures thereof.
A galvanic element which contains a conducting salt that is stable against anion dissociation.
A galvanic element which contains fluorine-free conducting salts such as lithium chelatoborates or lithium chelatophosphates.
An anode material for use in a galvanic element which in the discharged (low-Li) state contains or is composed of metal imide compounds of general formula (I)

M¹₄₋₂ₓM²ₓ(NH)₂·yLiNH₂ (I), where
M¹=alkali metal (Li, Na, K, Rb, Cs, or any given mixture thereof)
M²=alkaline earth element (Mg, Ca, Sr, Ba, or any given mixture thereof)
x and y independently stand for a number between 0 and 1,
or in the charged (Li-rich) state contains or is composed of metal imide compounds of general formula (II)

Li₄M¹₄₋₂ₓM²ₓ(NH)₂·yLiH (II), where
M¹=alkali metal (Li, Na, K, Rb, Cs, or any given mixture thereof)
M²=alkaline earth element (Mg, Ca, Sr, Ba, or any given mixture thereof)
x and y independently stand for a number between 0 and 1,
as active material.)
An anode material which in the discharged state contains or is composed of Li₂NH, MgNH, Li₂Mg(NH)₂, Li₂Ca(NH)₂, MgCa(NH)₂, Li₄Mg(NH)₃, or Li₂Mg₂(NH)₃ as active material.
An anode material which in the charged state contains or is composed of Li₄NH, Li₂MgNH, Li₆Mg(NH)₂, Li₆Ca(NH)₂, Li₄MgCa(NH)₂, Li₁₀Mg(NH)₃, or Li₈Mg₂(NH)₃ as active material.
A method for preparing an active material in which metal imides M³_{2/y}NH are reacted with metals M⁴ according to the following equation:

n(M³_{2/y}NH+2/zM⁴)→(M⁴M³_{2/y}NH)ₙ
where M³ and M⁴ independently stand for Li, Na, K, Rb, Cs, Mg, Ca, Sr, Ba
y and z stand for the valency of the metals M³ and M⁴ and
n is a number between 1 and 5.
A method in which the reaction is carried out either in the solid phase at temperatures between 100 and 600° C., or in a solvent suspension in a solvent that is inert with respect to raw materials and products, at temperatures between 100 and 300° C.
A method in which lithium amide is reacted with 2 mole equivalents of lithium metal to produce lithium imide/lithium hydride mixtures.
A method in which the reaction is carried out in the solid phase at temperatures between 100 and 300° C., or in a solvent suspension in a solvent that is inert with respect to raw materials and products, at temperatures between 100 and 300° C.
A method in which the lithium metal and the lithium amide are used in finely divided form (particle size <50 μm).
A method in which saturated or unsaturated hydrocarbons, preferably having boiling points above 100° C., are used as inert solvent.

The invention is explained with reference to the following examples and figures, which show the following:

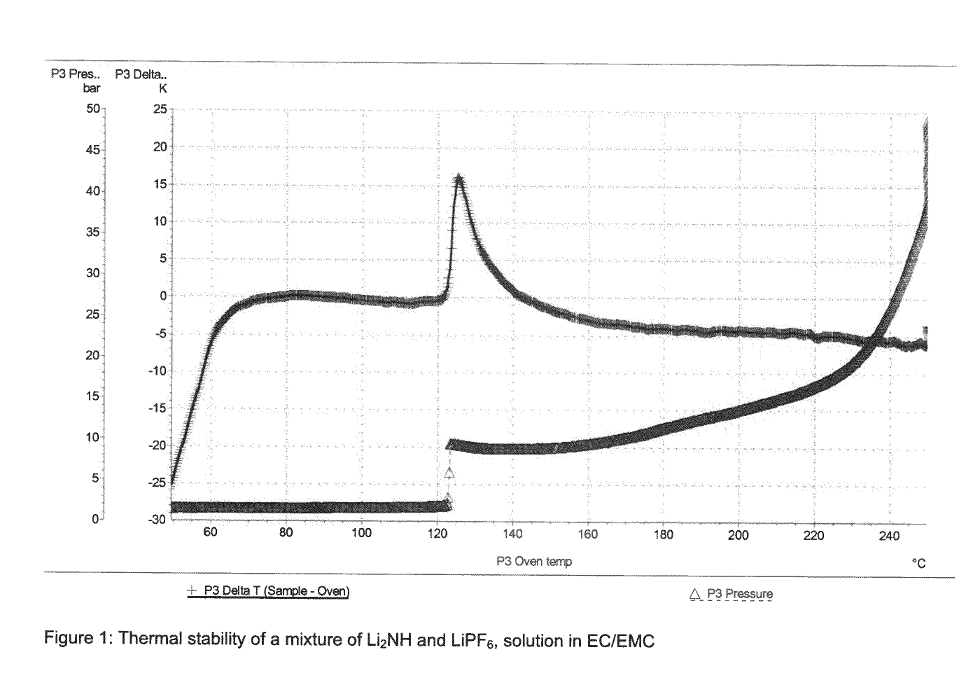

FIG. 1: shows the thermal stability of a mixture of Li₂NH and LiPF₆, solution in EC/EMC

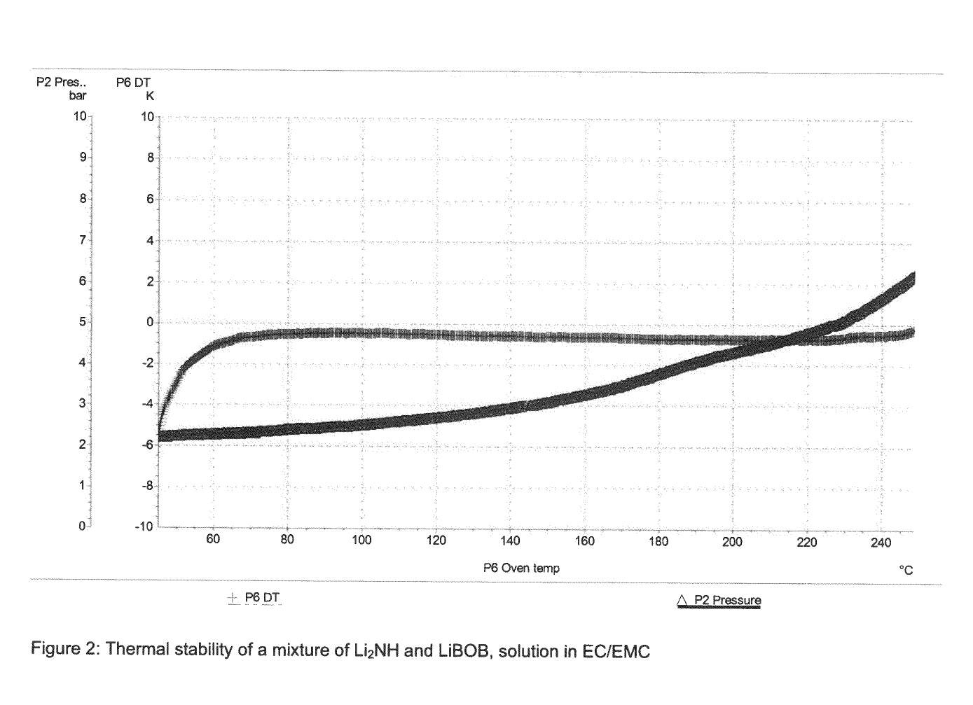

FIG. 2: shows the thermal stability of a mixture of Li₂NH and LiBOB, solution in EC/EMC

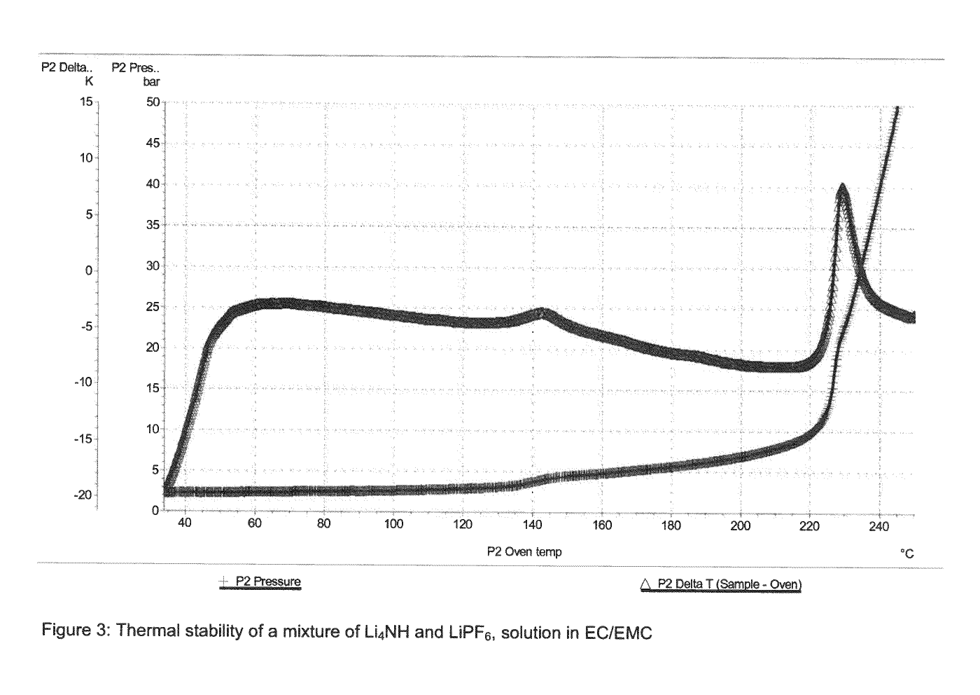

FIG. 3: shows the thermal stability of a mixture of Li₄NH and LiPF₆, solution in EC/EMC

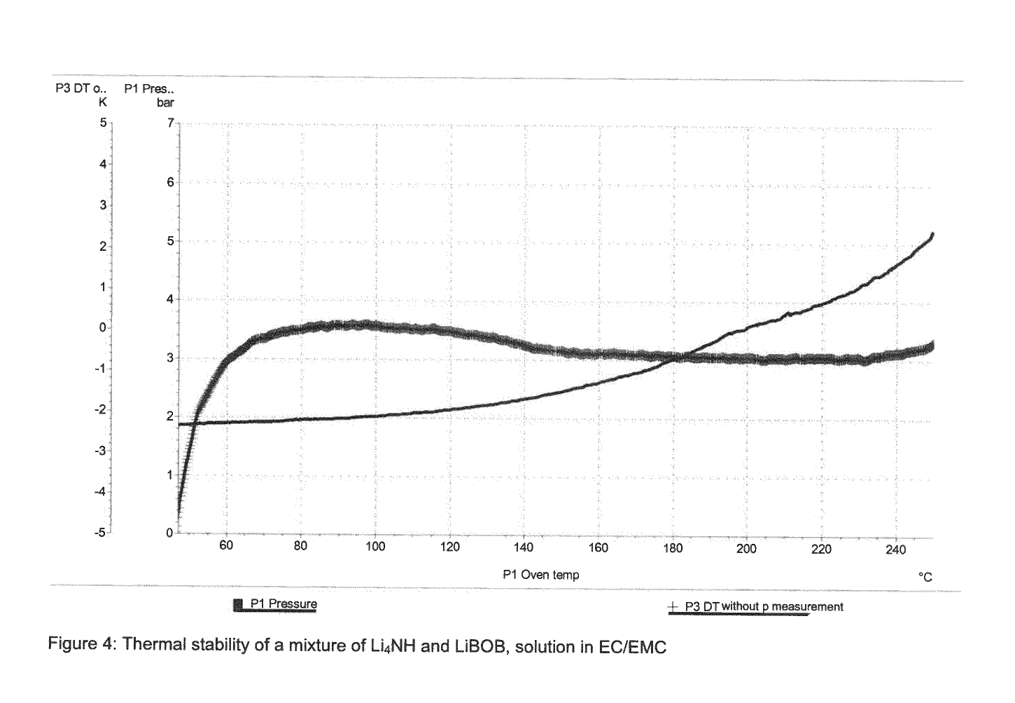

FIG. 4: shows the thermal stability of a mixture of Li₄NH and LiBOB, solution in EC/EMC

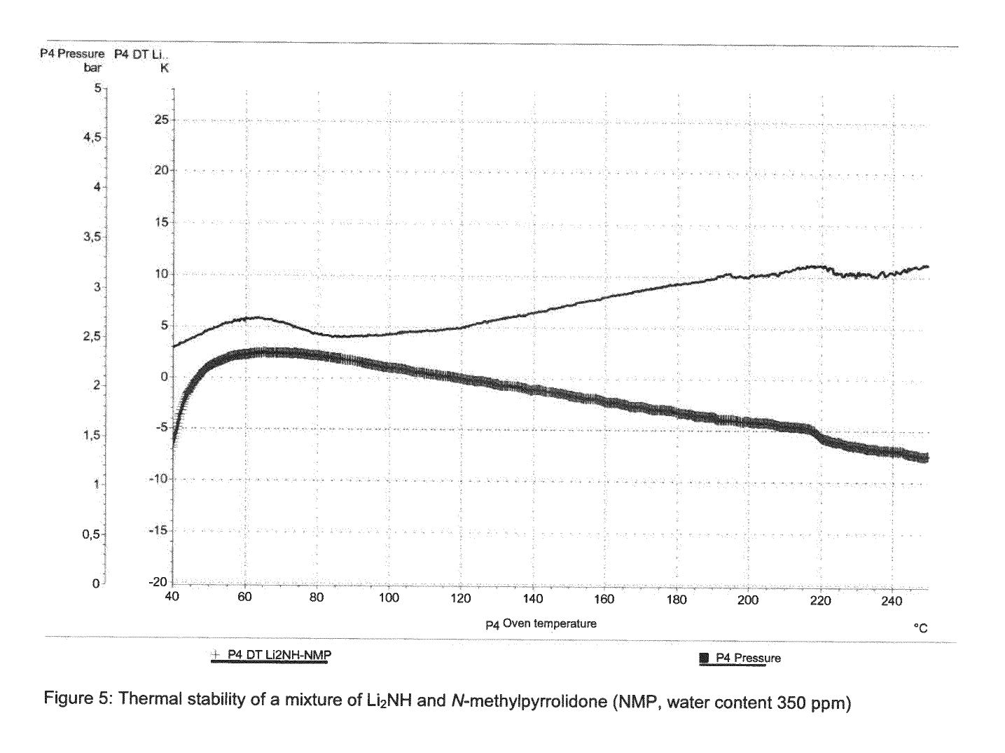

FIG. 5: shows the thermal stability of a mixture of Li₂NH and N-methylpyrrolidone (NMP, water content 350 ppm)

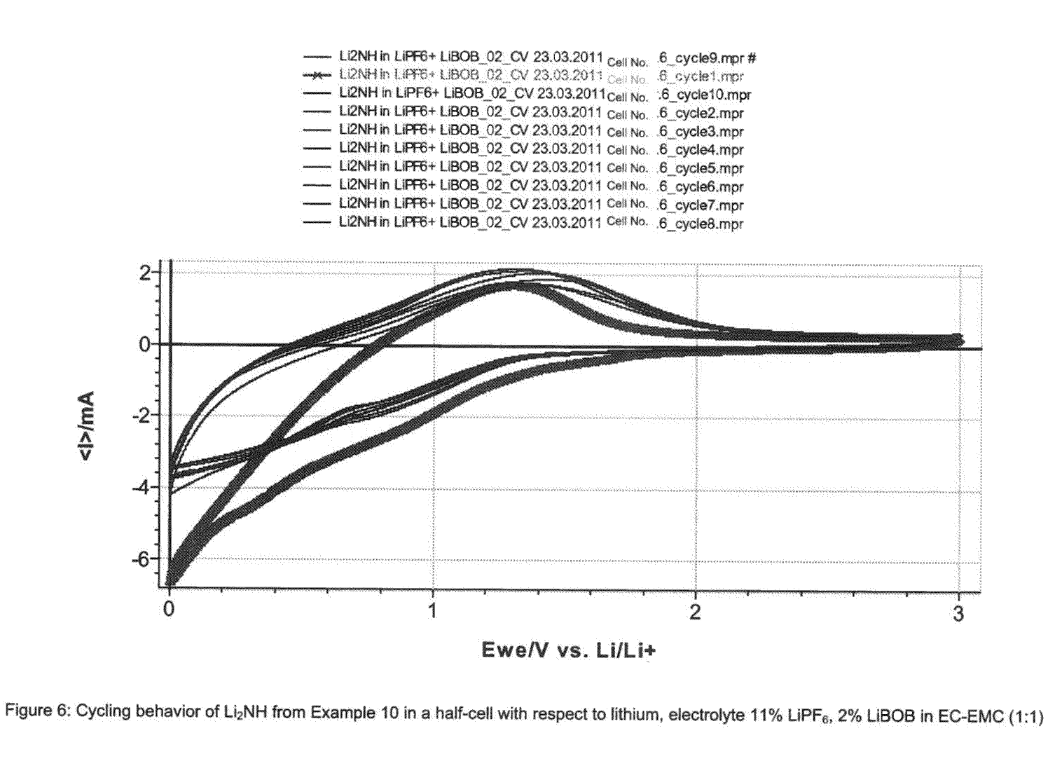

FIG. 6: shows cycling behavior of Li₂NH from Example 10 in a half-cell with respect to lithium, electrolyte 11% LiPF₆, 2% LiBOB in EC-EMC (1:1)

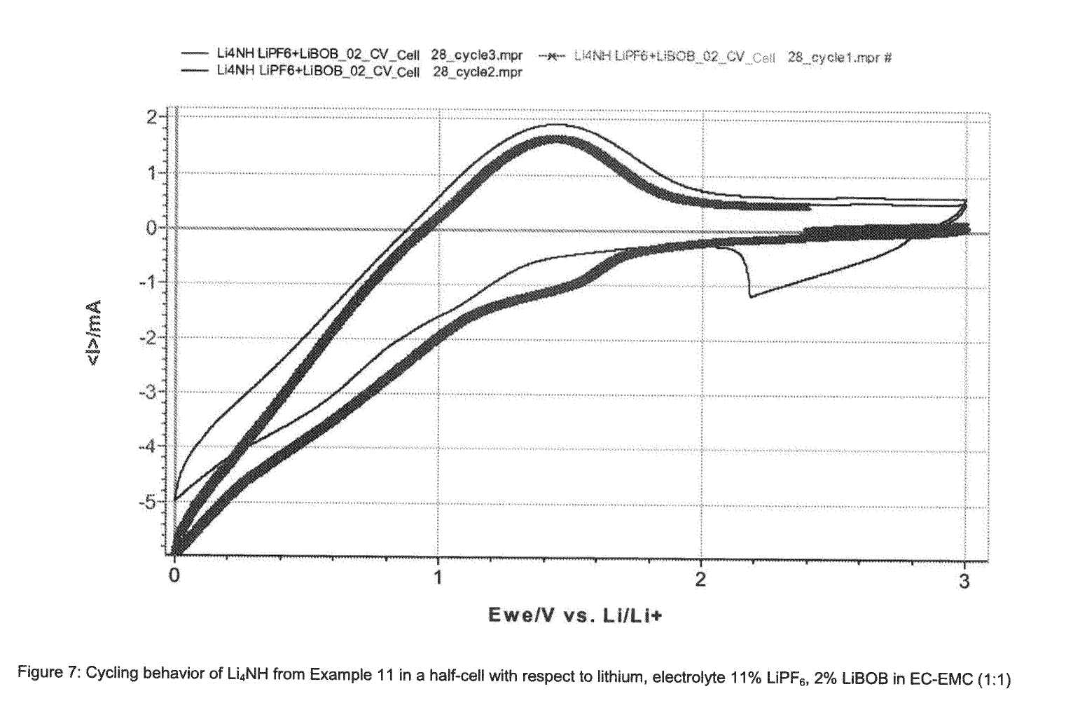

FIG. 7: shows cycling behavior of Li₄NH from Example 11 in a half-cell with respect to lithium, electrolyte 11% LiPF₆, 2% LiBOB in EC-EMC (1:1)

### EXAMPLE 1

### Preparation of Lithium Imide (Li₂NH) from LiNH₂ and Li₃N (Equation 13)

In an argon (Ar)-filled glove box, a pipe bomb autoclave having a capacity of 250 mL and equipped with a pressure indicator was filled with a mixture of 8.04 g ground LiNH₂ and 12.19 g ground Li₃N, and heated to 260° C. over a period of 1 hour (h). The reaction was continued at 300° C. for an additional 3 h. There was no pressure build-up during the synthesis (0.3 bar maximum). After cooling to room temperature (RT), the resulting product was filled into an Ar-filled storage vessel under an Ar atmosphere.

Yield: 19.5 g (96% of theoretical) of a colorless powder

X-ray diffraction (XRD): phase shift-free Li₂NH

### EXAMPLE 2

### Preparation of a Mixture of Lithium Imide (Li₂NH) and Lithium Hydride (LiH) from Lithium Amide (LiNH₂) and Lithium Metal (Equation 15)

In the pipe bomb autoclave from Example 1, a homogenized mixture of 6.20 g powdered lithium amide and 3.75 g lithium metal powder was heated to 230° C. under an Ar atmosphere. When the temperature exceeded approximately 180° C., the pressure suddenly rose from <0.2 bar to 6.2 bar, and the temperature rise to the target temperature of 230° C. was accelerated by the exothermic reaction which occurred. The reaction was continued at 230° C. for an additional one-half hour, whereupon the pressure dropped to 2 bar. The mixture was then cooled to RT, and the partially powdered, partially slightly agglomerated product was filled into an inerted glass flask.

Yield: 9.7 g (97% of theoretical) of a colorless solid

XRD: mixture of LiH and Li₂NH

### EXAMPLE 3

### Preparation of Lithium Nitride Hydride (Li₄NH) from Lithium Imide (Li₂NH) and Lithium Metal (Equation 21)

In the pipe bomb autoclave from Example 1, a homogenized mixture of 16.3 g powdered lithium imide and 7.83 g lithium metal powder was initially heated to 220° C. under an Ar atmosphere. When the temperature exceeded 200° C., which was recognizable by a brief temperature rise to 224° C., an exothermic reaction began. After temperature equilibrium was established, the reaction was continued at 300° C. for an additional 1.5 h. The mixture was cooled to RT and filled into an Ar-filled storage vessel under an Ar atmosphere.

Yield: 22.4 g (93 of theoretical) of a colorless, partly agglomerated powder

XRD: essentially phase shift-free Li₄NH

### EXAMPLE 4

### Stability of Lithium Imide with Respect to LiPF₆ in EC/EMC

0.10 g lithium imide powder from Example 1 and 2.53 g of a 12% solution of LiPF₆ in ethylene carbonate (EC) and ethylmethyl carbonate (EMC) in a 1:1 (wt:wt) EC/EMC weight ratio were filled into a 3-mL steel autoclave from Systag, Switzerland, and sealed with a lid having an attached pressure sensor. The autoclave was heated to 250° C. in a differential scanning calorimetry (DSC) Radex apparatus from Systag. The result is shown in FIG. 1: this mixture shows no thermochemical effects up to approximately 120° C., and is therefore stable. Exceedance of an oven temperature of 123° C. resulted in an abrupt pressure build-up (9 bar) accompanied by an intense exothermic peak. The mixture decomposed at the indicated temperature. At the end of the test, i.e., at an oven temperature of 250° C., the pressure had risen to approximately 40 bar. This indicates the formation of gaseous or vaporous decomposition products.

### EXAMPLE 5

### Stability of Lithium Imide with Respect to LiBOB in EC/EMC

0.10 g Li₂NH powder and 2.96 g of a 12% lithium bis(oxalato)borate (LiBOB) solution in EC/EMC (1:1, wt:wt) were filled into the same apparatus as in Example 4 and sealed with a lid having an attached pressure sensor. As is apparent from FIG. 2, until the final temperature of the DSC measurement (250° C.) was reached, neither a thermal effect nor a pressure build-up exceeding the natural solvent vapor pressure was recorded. This demonstrates the exceptionally good stability of the test mixture.

### EXAMPLE 6

### Stability of Lithium Nitride Hydride with Respect to LiPF₆ in EC/EMC

0.10 g Li₄NH powder and 2.52 g of a 12% LiPF₆ solution in EC/EMC (1:1, wt:wt) were filled into the same apparatus as in Example 4 and sealed with a lid having an attached pressure sensor. As is apparent from FIG. 3, at peak temperatures of 145° C. and 230° C. the system shows a fairly weak and a very intense exothermic result, respectively. In particular, the latter is associated with a strong pressure build-up (the final pressure at 250° C. was 50 bar). Thus, the observed system is stable only up to a temperature of approximately 120° C.

### EXAMPLE 7

### Stability of Lithium Nitride Hydride with Respect to LiBOB in EC/EMC

0.10 g Li₄NH powder and 2.74 g of a 12% LiBOB solution in EC/EMC (1:1, wt:wt) were filled into the same apparatus as in Example 4 and sealed with a lid having an attached pressure sensor. As is apparent from FIG. 4, until the final temperature of the DSC measurement (250° C.) was reached, neither a thermal effect nor a pressure build-up exceeding the natural solvent vapor pressure was recorded. This demonstrates the exceptionally good stability of the test mixture.

### EXAMPLE 8

### Stability of Lithium Imide with Respect to NMP (2 methylpyrrolidone)

0.10 g Li₂NH powder and 1.90 g NMP (350 ppm water content) were filled into the same apparatus as in Example 4 and sealed with a lid having an attached pressure sensor. As is apparent from FIG. 5, no significant exothermic behavior was observed up to the final temperature of 250° C. However, at higher water contents, for example 1.3%, exothermic decomposition was recorded, even at relatively low temperatures (50-60° C.) (no figure).

### EXAMPLE 9

### Production of an Anode According to the Invention, using Li₂NH as Active Material

5.5 g lithium imide powder from Example 1, 3.3 g PTFE powder (Aldrich), and 1.3 g conductive carbon black (C45 from Timcal) were premixed in a glass flask, and then ground in an agate mortar, in an Ar-filled glove box. The homogeneous powder was then pressed at a pressure of 2 t into a pure nickel mesh rondelle, which was used as a current collector.

### EXAMPLE 10

### Production of a Galvanic Half-Cell Using Li₂NH as Active Material, and Charge/Discharge Tests

The pressed round anode from Example 9 was mounted to an electrochemical cell in a Swagelok-like test cell, using a counter electrode and reference electrode made of pure lithium sheets. A solution containing 11% LiPF₆ and 2% LiBOB was used as electrolyte. The cell assembly was placed in an Ar-filied glove box due to the sensitivity to air of the materials used.

The cell was then subjected to charge/discharge cycles, using a potentiostat (the first 10 cycles are illustrated in FIG. 6). The charge/discharge rates were constant at 1 C.

It is apparent that the cathode according to the invention is able to reversibly insert and deinsert lithium.

### EXAMPLE 11

### Production of a Galvanic Half-Cell Using Li₄NH as Active Material, and Charge/Discharge Tests

In an Ar-filled glove box, a dry mixture of 65% lithium nitride hydride powder (from Example 3) with 33% PTFE powder and 2% conductive carbon black C45 was prepared as described in Example 9, finely ground, and pressed onto nickel mesh (2 t pressing force).

The pressed part was used to produce an electrochemical cell analogously to Example 10. The cell was cycled at a constant charge/discharge regime of 1 C. As is apparent from FIG. 7, lithium may be reversibly inserted and deinserted, also in Li₄NH, with high efficiency.

1.-20. (canceled)

21. A galvanic element comprising a metal imide compound of formula (I)
M¹₄₋₂ₓM²ₓ(NH)₂·yM¹NH₂ (I), wherein
M1 is an alkali metal selected from the group consisting of Li, Na, K, Rb, Cs;
M2 is an alkaline earth element elected from the group consisting if Mg, Ca, Sr and Ba;
x and y each independently represent a number between 0 and 1 in the discharged state,
or a metal imide of formula (II)
Li₄M¹₄₋₂ₓM²ₓ(NH)₂·yLiH (II), wherein
M¹ is an alkali metal selected from the group consisting of Li, Na, K, Rh, Cs;
M² is an alkaline earth element elected from the group consisting if Mg, Ca, Sr and Ba;
x and y independently represent a number between 0 and 1
in the charged state.

22. A galvanic element according to claim 20, wherein in the discharged state the galvanic element a metal imide of formula (I) selected from the group consisting of Li₂NH, MgNH, Li₂Mg(NH)₂, Li₂Ca(NH)₂, MgCa(NH)₂, Li₄Mg(NH)₃ and Li₂Mg₂(NH)₃.

23. A galvanic element according to claim 20, wherein in the charged state the galvanic element comprises a metal imide of formula (I) selected from the group consisting of Li₄NH, Li₂MgNH, Li₆Mg(NH)₂, Li₆Ca(NH)₂, Li₄MgCa(NH)₂, Li₁₀Mg(NH); and Li₈Mg₂(NH).

24. A galvanic element according to claim 21, wherein in the discharged state the cathode comprises a layer-structured material, a spinel-structured material, an olivine structured material, a nonlithiated insertion compound and a conversion cathode material.

25. A galvanic element according to claim 21, wherein the galvanic element contains lithium salts having weakly coordinating, oxidation-stable anions, for example LiPF₆, lithium fluoroalkyl phosphates, LiBF₄, imide salts, lithium triflate (LiOSO₂CF₃), methide salts, LiClO₄, lithium chelatoborates, lithium fluorochelatoborates, lithium chelatophosphates, or lithium fluorochelatophosphates or any given mixtures thereof as conducting salt.

26. A galvanic element according to claim 25, wherein the galvanic element contains a conducting salt which is stable against anion dissociation.

27. A galvanic element according to claim 26, wherein the galvanic element contains fluorine-free conducting salts such as lithium chelatoborates or lithium chelatophosphates.

28. A galvanic element according to claim 27, wherein the galvanic element contains aprotic solvents selected from the substance classes of the carbonic acid esters, carboxylic acid esters, ethers, nitriles, tertiary amines, dialkylsulfoxides, lactones, sulfolane, or ionic liquids, either in pure form or in any given mixtures.

29. An anode material for use in a galvanic element according to claim 21, wherein in the discharged (low-Li) state the anode materials contain or are composed of metal imide compounds of formula (I)
M¹₄₋₂ₓM²ₓ(NH)₂·yLiNH₂ (I), where
M¹=alkali metal (Li, Na, K, Rb, Cs, or any given mixture thereof)
M²=alkaline earth element (Mg, Ca, Sr, Ba, or any given mixture thereof)
x and y independently stand for a number between 0 and 1,
or in the charged (Li-rich) state contain or are composed of metal imide compounds of formula (II)
Li₄M¹₄₋₂ₓM²ₓ(NH)₂·yLiH (II), where
M¹ is an alkali metal elected from the group consisting of Li, Na, K, Rb and Cs,
M² is an alkaline earth element selected from the group consisting of Mg, Ca, Sr and Ba;
x and y independently stand for a number between 0 and 1,
as active material.

30. An anode material according to claim 29, wherein in the discharged state the anode material comprises at least one member selected from the group consisting of Li₂NH, MgNH, Li₂Mg(NH)₂, Li₂Ca(NH)₂, MgCa(NH)₂, Li₄Mg(NH)₃ and Li₂Mg₂(NH)₃.

31. An anode material according to claim 29, wherein in the charged state anode material comprises at least one member selected from the group consisting of Li₄NH, Li₂MgNH, LiₒMg(NH)₂, Li₆Ca(NH)₂, Li₄MgCa(NH)₂ and Li₁₀Mg(NH)₃ Li₈Mg₂(NH)₃.

32. A method for preparing an active material according to claim 29, wherein metal imides M³_{2/y}NH are reacted with metals M⁴ according to the following equation:
n(M³_{2/y}NH+2/zM⁴)→(M⁴M³_{2/y}NH)ₙ
where M³ and M⁴ independently are selected from the group consisting of Li, Na, K, Rb, Cs, Mg, Ca, Sr and Ba;
y and z stand for the valency of the metals M³ and M⁴ and
n is a number between 1 and 5.

33. A method according to claim 32, wherein the reaction is can-led out either in the solid phase at temperatures between 100 and 600° C., or in a solvent suspension in a solvent that is inert with respect to raw materials and products, at temperatures between 100 and 300° C.

34. A method according to claim 32, wherein lithium amide is reacted with 2 mole equivalents of lithium metal to produce lithium imide/lithium hydride mixtures.

35. A method according to claim 34, wherein the reaction is carried out in the solid phase at temperatures between 100 and 300° C., or in a solvent suspension in a solvent that is inert with respect to raw materials and products, at temperatures between 100 and 300° C.

36. A method according to claim 34, wherein the lithium metal and the lithium amide are used in as particle size <50 μm.

37. A method for producing an anode coating containing a powdered metal imide anode material according to the invention, wherein the anode coating is produced by pressing dry powdered mixtures composed of the metal imide anode material, a binder, and optionally a conductivity-enhancing additive onto a suitable current collector.

38. A method according to claim 37, wherein the binder is a thermoplastic polymer and the conductivity-enhancing additive is a carbon black.

39. A method for producing an anode coating containing a powdered metal imide anode material according to the invention, wherein the anode coating is produced using a solvent.

40. A method according to claim 39, wherein a soluble polymeric binder is added and a conductivity-enhancing additive is added, wherein the conductivity-enhancing additive is carbon black.

41. A method according to claim 39, wherein the solvent is a soluble polydiene.

42. A method according to claim 40, wherein the soluble polymeric binder is polyvinylidene fluoride (PVDF) and the solvent is selected from the group consisting of (N-methyl pyrrolidone) (NMP), N-ethylpynrolidone, (NEP), dimethylsulfoxide (DMSO), or λ-butyrolactone (GBL).

43. A method according to claim 41, wherein the polydiene is selected from the group consisting of polybutadiene and polyisobutylene.

44. A galvanic element according to claim 24, wherein the layer structured material is selected from the group consisting of LiCoO₂, LiNiO₂, Li(Ni,Mn,Co)O₂, and LiNi_{0.80}Co_{0.15}Al_{0.05}O₂.

45. A galvanic element according to claim 24, wherein the spinel-structured material is selected from the group consisting of LiMn₂O₄ and LiNi_{0.5}Mn_{1.5}O₄.

46. A galvanic element according to claim 24, wherein the olivine structured material is selected from the group consisting of LiFePO₄ and LiMnPO₄.

47. A galvanic element according to claim 24, wherein the olivine structured material is selected from the group consisting of electrolytic manganese dioxide (MnO₂) and electrolytic vanadium oxide (V₂O₃).

48. A galvanic element according to claim 24, wherein the conversion cathode material is selected from the group consisting of a metal fluoride, a metal oxyfluoride and a lithium oxide.
